(19) United States
(12) Patent Application Publication
(10) Pub. No.: US 2006/0282284 A1
(43) Pub. Date: Dec. 14, 2006

(54) Truck-trailer unloading services management system and method

(76) Inventors: Charles A. Daniel, Mt. Vernon, MO (US); Wally Jones, Springfield, MO (US)

Correspondence Address: Jonathan A. Bay;Attorney at Law, Suite 314, 333 Park Central East, Springfield, MO, 65806, US

(21) Appl. No.: 11/496,115

(22) Filed: Jul. 31, 2006

Related U.S. Application Data
(63) Continuation-in-part of application No. 11/371,212, filed on Mar. 7, 2006.
Application No. 11/371,212 is a continuation of application No. 60/659,209, filed on Mar. 7, 2005.

(51) Int. Cl. G06Q 99/00

(52) U.S. Cl. 705/1

(57) ABSTRACT

A method of managing trailer-truck unloading services fees in a conduction of goods market with a large-scale buyer comprises establishing a service-provider which subscribes customers from predominantly among a seller community. The service-provider is designed to negotiate terms with the unloading service regarding fees for trailer-truck unloading and product sorting at the receiving dock of the buyer's warehouse.

### CROSS-REFERENCE TO RELATED APPLICATION(S)

This application is continuation-in-part of U.S. patent application Ser. No. 11/371,212, filed Mar. 7, 2006, which claims the benefit of U.S. Provisional Application No. 60/659,209, filed Mar. 7, 2005. The foregoing disclosures are incorporated herein by this reference thereto.

### BACKGROUND OF THE INVENTION

1. Field of the Invention

The invention relates to the conduction of goods between enterprises (which includes among many other things a single enterprise's logistics or supply chain management) as well as, more particularly, a truck-trailer “unloading services” management system and method.

2. Prior Art

FIG. 1 shows how nowadays truck-trailer unloading is being transacted in accordance with the prior art among the various principal parties illustrated therein. The party which usually supplies the manpower (or worker power) for unloading a truck-trailer is referred to as the “unloading service.” In the industry, the actual workers who do the physical labor have been commonly called “lumpers.”

The following comprises a brief introduction of the parties, what their respective roles are in this general situation, and how to date they've managed business among each other in accordance with the prior art.

A typical “receiver” party might be a wholesaler or large chain of “big-box” retail stores. In Springfield, Mo., Associated Wholesale Grocers is a wholesaler which distributes product to a number of different independent retailers. Regardless if the receiver is a wholesaler or “big-box” retail store, FIG. 1 shows a receiver's preferred receiving site with which the invention is most concerned, and that might be a regional “warehouse.” These warehouses are distributions centers in that, articles of commerce unloaded at the regional warehouse would thereafter presumptively be distributed onward by receiver's own trucking lines (not shown) to a distributed local network of its independent customers or its corporately-affiliated “big-box” retail stores (neither are shown), respectively, in nearby towns or the like. Other aspects of a representative “receiver” party will be more particularly described below.

A “carrier” is typically a trucking enterprise. Some carriers are owned by or corporately affiliated with the receiver. Other carriers are owned by or corporately affiliated with the shipper. Still other carriers are trucking companies or enterprises independent of both the receiver and shippers.

Now, to turn briefly to these three kinds of carriers, if the carrier is owned or affiliated with the receiver, any unloading of product from these vehicles will be at the financial responsibility of the receiver. In the trade, these loads are classified under several names, including “logistic,” “customer pick-up” or “backhaul” loads. This condition may also apply with independent carriers if the receiver hires or contracts with them to make the delivery.

Otherwise, any unloading of product from these vehicles will be at the financial responsibility of the shipper. This is true regardless if the carrier is a shipper carrier or a carrier independent of the shipper and receiver. Examples of shippers who have carrier divisions include Kraft Foods of Chicago, Ill. or Tyson Foods of Springdale, Ark. The still other carriers who are independent of the receiver or shipper include numerous independents from large to small.

Excluding receiver carriers, the carrier typically has at its disposal a worker group, among other personnel, who are the actual “drivers” of the trucks. These drivers may be employees or independent contractors. The carrier also has another worker group at its disposal, who are “dispatchers.” Among other roles for dispatchers, they handle the transmission of instructions and information to drivers, as well as handle the incoming inquiries, status updates or problem alerts from drivers. In cases of problem alerts, the dispatchers might be the carrier's front-line response team who are responsible to finding and/or working out solutions.

A “shipper” is most likely to be a manufacturer or importer of the product being delivered. It is rare if the shipper is a wholesaler. Most shippers falling under the “wholesaler” category would most likely be vendors of general merchandise items, which they pre-select for the receiver's customers. These items are then shipped in a manner that allows them to be taken directly from the delivery vehicle to the receiver's truck under a process known as “cross docking.”

Now, the respective roles of these parties might be better described through an example. Consider how Wal-Mart configures its regional distribution centers. Wal-Mart differentiates its receiving docks into three kinds, depending on the articles of commerce each kind is designed to handle. That is, each Wal-Mart superstore is served by one special-purpose receiving dock for general commodities only, and then also another special-purpose receiving dock for receiving groceries only (eg., and in a technical sense meaning only dry freight, or that which requires no refrigeration/freezing). Third of all, each Wal-Mart superstore is served by a last special-purpose receiving dock which specializes in perishables only:—eg., things which do require refrigeration or freezing.

Now, the foregoing description of the Wal-Mart distribution arrangement describes three separate receiving docks. These separate receiving docks unload to warehouse facilities which, while separate in the products they hold, are normally located at the same address. The separate warehouse facilities may be separate areas in a single building or in two or more buildings in a single “campus.”

All three special-purpose receiving docks will outsource truck-trailer unloading to an outside contractor, aside from “straight pulls.” That is, if a shipper has configured the load in the trailer for a “straight pull,” then these are often handled by the receiver's own employees. While a majority of the deliveries to a receiver are “trailer load” quantities, the trailer-load delivery commonly includes numerous products which must be sorted for storage in the receiver's warehouse. Hence such an outside contractor for unloading services is more economical. Regardless that “trailer load” and “straight pull” are nominally technical terms, “straight pull” loads in contrast to non-straight pull “trailer load” quantities signify typical situations where a warehouse can pull out the load with its own employees just as cost-effectively as outside “lumpers.”

However, some facilities do allow the unloading service to handle “straight pull” loads too as part of its service offering.

Not as common as “trailer load” deliveries (whether “straight pull” or not), there are also “less-than trailer load” deliveries, otherwise referred to as LTL in the industry. Hence, a trailer is loaded in this situation to deliver, eg., six pallets at one stop, perhaps five pallets at another stop, then maybe seven more pallets at a succeeding stop, and so on. LTL deliveries are often mixed among all product categories delivered to the warehouse. Most of the dry or non-food LTL deliveries are made by a specialized carrier, which commonly require that the unloading be done by their driver who is paid an hourly rate to specifically make deliveries and pick up shipments at local area docks.

But where outside “unloading-service” contractors flourish is with the unloading of “trailer load” or “less-than trailer load” deliveries of perishables in particular. The delivery brings in palletized articles of commerce. Also, each pallet may contain diverse articles of commerce. And so what has evolved is a specialist worker—ie., an unloader or “lumper”—who specializes in processing deliveries. Such skills involve unloading pallets, discerning distinguishable product and sorting it out according to the warehouse's purposes, properly stacking pallets, re-securing the less-than trailer full load that remains to prevent damage and the like, and then doing so efficiently and safely and so on. Thus unloading or lumping really is a skilled or semi-skilled trade of workers or service organizations who can offer valuable efficiencies:—when they are motivated.

Indeed, there are plenty of shortcomings with the foregoing arrangements, which often put the parties at cross-competitive purposes. Let's re-consider the “receiver” party. It typically is a large organization, one which has individuals implementing different policies not all designed to advance the common larger goals of the organization. For example, one large-scale goal of a retailer is to keep the cost of goods down, including the cost of conduction of goods from shipper to store shelf. Hence cost run-ups among the shipper, carrier and unloading service will likely ultimately cause upward pressure on the cost of goods. However, at the warehouse level, the warehouse managers look upon the unloading service as a profit center. This works this way. The warehouse manager puts the unloading contract up for bid. The low bidder will likely win the award. However, the low bidder may have bid so low that it can not reasonably make a decent profit between the gross revenue earned off the charges to receiver and the cost of doing business which includes in part the contract price.

Hence the warehouse manager conducts a bidding process for an unloading service to be authorized to operate on the receiver's warehouse docks. The winning bid pays a contract price, which the warehouse manager gets to report to his or her employer the receiver as bread-winning revenue. The bid is normally based on the work which will be billed to the receiver and not the shipper/carrier. This is where lower-than-cost rates show up. The bidder bids a lower-than-cost rate for work charged to the receiver. However, for charges to the shippers/carriers, the receiver either ignores that the unloading service may be overcharging the shippers/carriers or else encourages the unloading service to overcharge the shippers/carriers in order to make up for lost revenue on the receiver-paid loads.

The foregoing situation introduces all kinds of inefficiencies to the system. Briefly for the moment, the unloading service is motivated in part to find all kinds of fault on the shipper's or carrier's part in order that the unloading service may charge surcharges as well. Nowadays it is the typical practice that a driver and lumper negotiate a charge at the instance of every trailer docking up to the dock. Hence every time a trailer is docked, there is a little drama that plays out which can result in any kind of mischief. The following provides a more particular description of these and other kinds of shortcomings that bedevil the unloading service industry today.

Presently, the unloading service industry is not operating much more professionally than it did when independent lumpers were the rule. Rates are negotiated on almost every load between the driver and unloading service. This dickering over the rate can take several minutes. Many times the driver must call his or her dispatcher for authorization and money transfer numbers for payment. Some shippers have given their carriers blank check authority to just get the product unloaded. However, occasionally, the dispatcher has to contact the shipper for authorization if the rate is higher than the shipper has authorized the carrier to spend. Hence the dispatcher had to take a call from the driver, then place a call to the shipper and then, after that, call the driver back with authorization or not, in which case the driver is given instructions to process the load him or herself. This exchange can take up to an hour or longer. If the driver handles the work, this cuts deeply into the total workday allowed drivers under the U.S. Department of Transportation (“USDOT”) Hours of Service Rules. It consequently reduces the driver's income potential.

These negotiations and authorization calls delay the processing of the load, which is still on the trailer sitting against the loading dock. These delays are costly for everyone involved, as will be described later.

As an aside, some shippers have tried to institute caps on how much they will authorize for unloading. But this generally backfired and resulted in seeing unloading services refuse to unload the product. In the end, the carrier was left with the responsibility to either cover the overage, or else return the load, both of which were bad business.

To return to the authorization scene, if authorization is given, then the unloading service has to be satisfied with payment. If the driver pays with a check (T-Check, TCH, EFS, etc.), then the service has to get an authorization code that verifies the money transfer code the driver gave for payment before the check can be taken to the bank. Any discrepancy with the transfer code means that the unloading service has to verify the numbers with the driver or carrier and call the check issuer again for authorization. If a driver pays with cash, the unloading service may have to send an employee (usually a supervisor) to get change, which can leave the service understaffed at the dock for a time.

With cash and checks being exchanged, there is always the potential for theft and fraud. Individual unloaders have been known to take a driver's payment and then tell the supervisor that the driver processed the load himself, while pocketing the money. Also, drivers have been known to alter the amount on an unloading service's receipt to receive a higher reimbursement from the carrier, or to give an unloading service an intentionally incorrect money transfer code in order to present the correct code to a nearby truck stop and pocket the proceeds as well as cause the unloading service to be completely unpaid for the service they performed. Consequently, the present system is rife with problems.

And if the foregoing aren't bad enough, there are further problems with inconsistent rates. The inventors hereof have long experience in this business, and have seen great discrepancy among rates being charged for unloading services, not only between different facilities but also at different times on a single dock. For example, identical loads of strawberries delivered to a given warehouse in Chicago were unloaded for $80.00 at 8:00 a.m., but the quoted rate would be anywhere between $140.00 and $200.00 by later than 11:00 a.m. Now, in that example, the labor each load entailed was the same:—namely, that is, the labor entailed pulling the pallets from the truck and then merely removing the plastic netting which was wrapped around the pallets. At another location, the rate for unloading yogurt products was $300.00 without regard to the size of the load.

Additionally, the carriers have costs associated with processing these payments, and these costs typically are of an overhead nature that cannot be passed on to the shippers (or at least shippers are accustomed to not accepting such charges and hence resist such charges strongly). Many carriers use check payment services for security and accounting purposes in making these payments. These services (T-Check, TCH, EFS, etc.) charge the carrier a fee for each check processed. These fees are normally based on the amount of each check and can range from a few cents to several dollars per check. Large fleet carriers making hundreds of deliveries per day can easily pay hundreds—to thousands—of dollars daily for such fees.

Also, the carriers have internal labor costs associated with processing these payments. In order to give the drivers authorization for the unloading fees, dispatchers have to be available to respond to the their calls. Since different warehouses accept (or expect or otherwise restrict) deliveries to be received at different times during the day, this means that dispatchers have to be “on duty” twenty-four hours a day. The carriers also have to utilize accounting and billing personnel to process the payments, match the unloading fees to the proper delivery, and include the fee on the shipper's invoice. The inventors hereof are aware of one small carrier which reported that it had to have a full-time employee just to handle the processing of unloading fees.

To turn to another of the carrier's cost of doing business, all of the communications add to the carrier's telephone expense. Many carriers use satellite-based systems, such as QualComm, which is a premium service not only as technology goes but also cost.

Except for the actual “basic” unloading fees, the carrier cannot pass any of these other costs on to the shipper. In some cases where the “basic” unloading fee is exorbitant, the carrier even has to absorb a portion of them, too.

The foregoing section has concentrated on the carriers woes under the present state of things. The following section will examine some of the factors that receivers experience which beg for change.

Earlier above a situation was examined using Wal-Mart as the example. Many would say without causing argument that Wal-Mart is the definition of “big-box” retailer. However, the problems for receivers that are to be examined here are for receivers which are not necessarily “big-box” retailers but instead are of an intermediate or smaller size such that they are being pressured by the “big-box” stores to reduce costs anywhere they can in order to remain competitive. Simply put, companies like Wal-Mart and Target have economies of scale such that, along with the effects of their volume purchasing, it allows them to more readily offer lower prices than non-big box retailers.

At the operations level at many warehouses, local management looks at the unloading work, erroneously, as a potential profit center. This “extra income” is used to improve the company's perceived value in these individuals and operations. The local management requires the unloading service to process loads for which the warehouse covers the cost at rates that barely meet the service's cost to operate in order to be the approved service at the facility. The service is then given instructions to make up their loss by overcharging to process loads that the carriers and/or vendors pay to have unloaded. But, from this income, the unloading service has to pay the warehouse for the right to remain their approved service. These payments range from flat equipment rental fees as one example to facility fees as another that are a percentage of the gross revenue generated by the unloading service at the facility. Some warehouses even instruct the service to add specific amounts to their rates, which are turned over to the warehouse along with a percentage from the service's basic rates. Purportedly, one warehouse facility supposedly require their commissioned unloading service to tack on $100.00 or more to the cost of processing a full truck load. These policies of the local warehouse management are very shortsighted from corporate as-a-whole perspective because the surcharges tacked onto the unloading transactions only adds to the cost of goods sold for the retailer and thereby not surprisingly diminishes that retailers overall competitive position.

What is needed is an improvement which overcomes these and other shortcomings.

### SUMMARY OF THE INVENTION

It is an object of the invention to provide a truck-trailer unloading services management system and method in accordance with the invention that is truly a win-win-win-win situation for all the parties

Additional aspects and objects of the invention will be apparent in connection with the discussion further below of preferred embodiments and examples.

### BRIEF DESCRIPTION OF THE DRAWINGS

There are shown in the drawings certain exemplary embodiments of the invention as presently preferred. It should be understood that the invention is not limited to the embodiments disclosed as examples, and is capable of variation within the scope of the appended claims. In the drawings,

FIG. 1 is a block diagram view of how the truck-trailer unloading business is nowadays practiced in accordance with the prior art;

FIG. 2 is a comparable block diagram view except showing a truck-trailer unloading services management system and method in accordance with the invention;

FIG. 3 is a block diagram view of how fair trade forces should govern the truck-trailer unloading business as nowadays practiced;

FIG. 4 is a block diagram view of showing how fair trade in the present day the truck-trailer unloading market is unduly influenced by one party in particular; and

FIG. 5 is a block diagram view comparable to FIG. 4 except showing the inclusion of truck-trailer unloading services management system and method in accordance with the invention in order to tip the balance in the conduction of goods market to a state of fairness among all the parties, and in their common welfare as a whole.

### DETAILED DESCRIPTION OF THE PREFERRED EMBODIMENTS

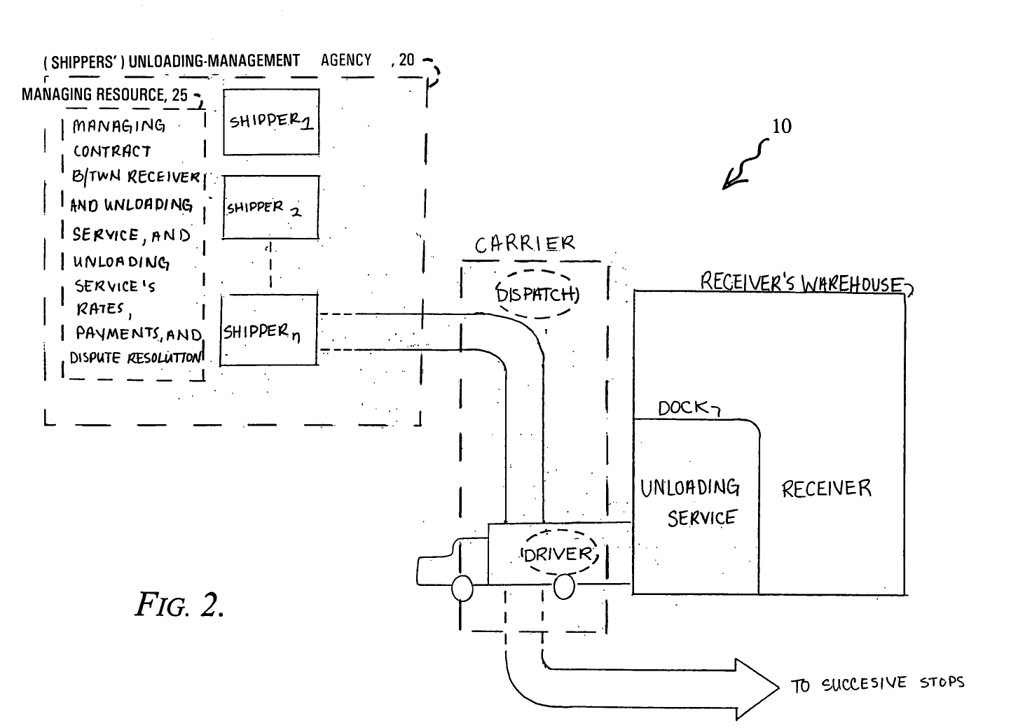

FIG. 2 shows a truck-trailer unloading services management system and method 10 in accordance with the invention. An initial policy to be implemented for curbing these costs is to outsource the carriers' role in managing the unloading and/or negotiating the rates for the service. At the dock, the driver's main interest is to beat the clock and get his or her truck back on the road. Therefore, he or she does not have a vested interest in obtaining a fair price for the unloading process and consequently is more likely to accept unreasonable fees just to get the product unloaded as fast as possible. Removing the drivers from the equation allows the carriers to concentrate on their core competency of transporting product for their customers.

Another policy to be implemented is the establishment of fair, consistent pricing for unloading services. These rates are to be set in a way that helps the shippers and receivers keep their costs under control while allowing the unloaders to earn a fair, honest income from their labors. When everyone knows the price in advance, it becomes easier for all of the parties in the transaction to efficiently participate.

The foregoing aspects of the truck-trailer unloading services management system and method 10 in accordance with the invention are expediently accomplished through the establishment of a shippers' unloading-management agent, and as indicated by reference numeral 20 in FIG. 2. This unloading-management agent 20 has direct control over the rates. It also handles the payment for unloading services. The unloading-management agent 20 uses its expertise in this arena to help the shippers develop and negotiate an honest rate schedule. The rate schedule is developed by reviewing the shipments to each receiving location in order to properly estimate the amount of labor required. The labor requirements to process deliveries may vary from warehouse to warehouse depending on the receiver's (eg., customer's) buying patterns and the product mix on each load. Any particular shipper will have the opportunity to review and approve all pricing before it is put into effect.

In addition to establishing the basic unloading fee structure, the unloading-management agent 20 furthermore develops rates to cover those special circumstances that can impact the unloading process. For example, product may be loaded on a pallet with imperceptible cracks in the boards that can expand to full breaks during transit. Product arriving on these “bad pallets” has to be transferred to “good wood” before going into the warehouse's storage system. Also, loads that are not fully locked in place in the trailer can shift during transfer, which takes additional labor to re-stack. These special services fees will also be presented in the agency 20's negotiations with receivers on behalf of the shippers retaining the agency 20 for their fee structure with the receiver.

Finally, all of the rates are locked in through contracts. The participating shippers thus enjoy having a contract with the unloading-management agent 20 to cover all shipments, and the unloading services benefit as well by having contracts with prices clearly listed for all loads to be processed.

The unloading-management agent 20 has one or more central offices indicated by reference numeral 25 in FIG. 2 (only one schematic block is illustrated therefor, and is denominated as the “managing resource” 25). This managing resource 25 is charged with the responsibility of carrying out the truck-trailer unloading-management system and method 10 in accordance with the invention. The managing resource 25 represents all the participating shippers in negotiating with the unloading services. This provides the participating shippers with the strength in numbers to induce the unloading services' decision to participate in the truck-trailer unloading services management system and method 10 in accordance with the invention. By representing twenty to thirty of the largest shippers, the unloading-management agent 20 can govern over or otherwise influence seventy-five percent or more of the freight coming onto the receiving docks.

The unloading-management agent 20 will serve as the conduit for all communications between the unloading services and the shippers. This gives both the shippers and unloaders a single point of contact (ie., through the managing resource 25) regardless of the origin or destination of the products involved. Since this includes all billing for services rendered, the shippers are now going to receive consolidated invoices for all unloading activities throughout the area covered by the agreements the agent 20 puts in place.

The unloading-management agent 20 will be responsible for providing participating shippers a detailed information spreadsheet on all loads with each invoice. The preferred data fields on the spreadsheet varies from shipper to shipper based on the shippers' individual requirements, but all such spreadsheets contain certain basic information. This certain basic information includes but is not limited to the following:—bill of lading number, delivery date, appointment time, actual arrival and departure time at the dock door, number of pallets and cases received, clear notation of overages/shortages/damages (OS&D), and so on.

The unloading-management agent 20 by and through the managing resource 25 thereof also receives consolidated payments from the participating shippers and thereafter reconciles and disperses the monies to the unloading services. Any disputed charges or services will be mediated by the unloading-management agent 20 as well.

The invention provides numerous advantages for all the parties. To begin with the participating shippers, they are beneficiaries to a clear cost structure for this aspect of delivery of product. Knowing the cost of unloading in advance allows shippers to more accurately quote the receivers (eg., their customers) a true bottom line price the shippers' products when the order is placed. The foregoing would eliminate in almost all cases the guesswork in estimating the total cost. The truck-trailer unloading services management system and method 10 in accordance with the invention also ends the calls from carriers requesting authorization for unloading fees.

Since every invoice has an accompanying data spreadsheet, shippers are relieved from the responsibility of matching the unloading cost to each shipment in order to authorize the freight bills. Also, any problems with the load is clearly noted to assist in making any adjustments to the shippers' final billing. All of this reduces the shippers' labor costs to process payments, and frees their employees to engage in more profitable efforts.

Now to turn to the advantages the truck-trailer unloading services management system and method 10 in accordance with the invention provides carriers, carriers are be freed from negotiating the cost for unloading services on every delivery. The delivery transaction can be handled faster and more efficiently without this delay. Also, drivers do not have to get involved in doing the work themselves as they do now at places where the unloading fees are unreasonably high. Since the unloading rates are pre-approved for every load, the carriers' communication costs are also be reduced. Pre-set rates also reduce the opportunity for drivers to “pad the bill” and receive reimbursement for more than was actually spent for unloading.

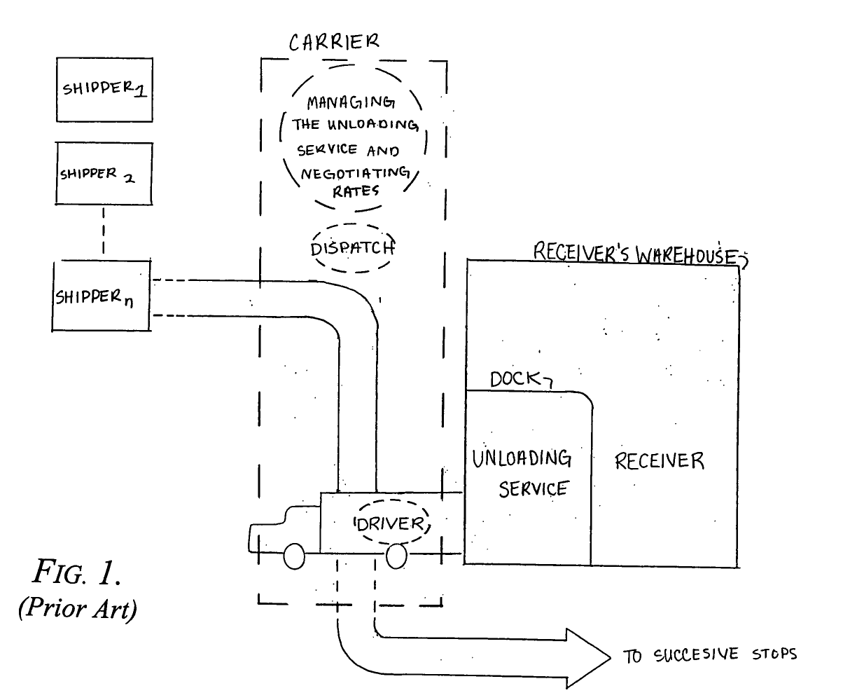

Carriers' internal costs associated with approving unloading services and processing the payments are reduced, as well. That is, the carriers have internal labor costs associated with processing these payments. In order to give the drivers authorization for the unloading fees, dispatchers have to be available to respond to the their calls. Since different warehouses accept (or expect or otherwise restrict) deliveries to be received at different times during the day, this means that dispatchers have to be “on duty” twenty-four hours a day. The carriers also have to utilize accounting and billing personnel to process the payments, match the unloading fees to the proper delivery, and include the fee on the shipper's invoice. The inventors hereof are aware of one small carrier which reported that it had to have a full-time employee just to handle the processing of unloading fees. The advantages provided by the invention drastically reduce if not eliminate many of the foregoing categories of internal costs. Also, the carriers are issuing fewer checks in contrast to the prior art way doing business (eg., FIG. 1), and hence the inventive way of doing business reduces carriers' expenses for check processing services.

Finally, and most importantly to the carriers, the truck-trailer unloading services management system and method 10 in accordance with the invention frees their drivers for more available hours of service under the USDOT's Hours of Service rules.

While at first blush it may seem that the truck-trailer unloading services management system and method 10 in accordance with the invention is designed to cut into the profitability of the unloading services, no such result is intended. In sharp contrast to that, the truck-trailer unloading services management system and method 10 in accordance with the invention is designed on their behalf to provide them, the unloading services, with long-term job security, accurate long-term forecasts of upcoming work volume, and fair pricing overall. Under the truck-trailer unloading services management system and method 10 in accordance with the invention, the unloading services are guaranteed the work to process the shippers' loads. The unloading services are provided with a preliminary receiving report and thereby determine the minimum number of loads they will service the next day. In contrast with how business is done in accordance with FIG. 1, this is just a guessing game. The unloading services are no longer negotiating with drivers over rates or over who will process the load. This allows the unloading services to make more realistic scheduling of number of workers. Hence this eliminates situations where an unloading service either has too many or too few unloaders available on the docks.

The unloading services are also reducing some of their own operating costs when they contract under the truck-trailer unloading services management system and method 10 in accordance with the invention. With a reduction in the amount of checks being received on the docks, the unloading services will reduce the number of phone calls to payment-service agencies for authorization codes. There are unlikely to be anymore lost payments due to accidental or intentional inaccuracies in the code the unloading services receive from drivers.

The truck-trailer unloading services management system and method 10 in accordance with the invention also eliminates cash transactions. Hence the unloading services will not need to have money available to make change for drivers who pay in cash.

By removing most of the exchange of cash and checks from the dock, there is an additional benefit to all the organizations in that the truck-trailer unloading services management system and method 10 in accordance with the invention tightly clamps down any opportunity for employee/worker theft to cut into any organization's revenue. This alone is going to save hundreds of dollars a month at a single facility.

To turn next to the benefits under the truck-trailer unloading services management system and method 10 in accordance with the invention for receivers, trailer unloading begins faster than under the prior art way of FIG. 1 since the unloading service and the driver no longer have to negotiate an acceptable rate. In consequence, warehouse employees are not wasting time waiting for product to put into inventory.

Faster starts to the unloading also allows for better scheduling of deliveries and increased turns on the dock doors. This leads to reduced incidences of the levy of detention charges:—a surcharge levied when where trailers are tied to the dock longer than a time limit (usually set at two hours, which is what most carriers and/or shippers consider to be normal unloading time).

With more unloading prearranged, far fewer drivers will be tempted out of frustration to process loads themselves. “Driver unloads” are a major cause of errors in proper product sorting and disposition as well as with incorrectly stacked pallets. Driver unloads also add to slower dock door turns and increased detention charges by causing other trucks to be delayed. Of course, anything that slows the unloading process increases the probability of warehouse employees being required to work overtime, which increases the receiver's operating costs. Accordingly, the truck-trailer unloading services management system and method 10 in accordance with the invention overcomes the shortcomings in this respect of the prior art way (eg., FIG. 1).

The unloading-management agent 20, by setting rates for the unloading and sorting of product at the receiver's docks, thereby provides better cost control for the receiver/retail organization. (Note that, the agent 20 does not set or is preferred not to become involved in setting the actual freight charges). Keeping the bottom line cost of goods sold in check means the receiver/retail organization can be more competitive at the retail level and realize increased sales and profits.

The concept of a truck-trailer unloading services management system and method 10 in accordance with the invention provides tangible benefits for everyone involved in producing and moving products from the manufacturer/shipper to receiver/retailer. The shippers, carriers, unloading services, and receivers/retailers all profit. The truck-trailer unloading services management system and method 10 in accordance with the invention is truly a win-win-win-win situation for all the parties. There are no losers here.

It is preferred (although without excluding its implementation in other situations) if the truck-trailer unloading services management system and method 10 in accordance with the invention is optimized for warehouses in the 800,000 square feet size range (^{˜}75,000 square meters). If so, there may be a size range where the policies of the truck-trailer unloading services management system and method 10 in accordance with the invention do not cost justify. This lower limit might be, and without limitation to be lower still, in the neighborhood of about 400,000 square feet (^{˜}37,500 square meters). In the other direction, there is no known reason why there would be an upper limit to the truck-trailer unloading services management system and method 10 in accordance with the invention. Indeed, presumptively, the larger, the more the money works. As an aside, to date the largest (prospective) U.S. commercial warehouse known to the inventor's hereof is a Southern California facility which although is under construction is planned to measure about 1,750,000 square feet (ie., 1¾ million square feet, or ^{˜}162,500 square meters).

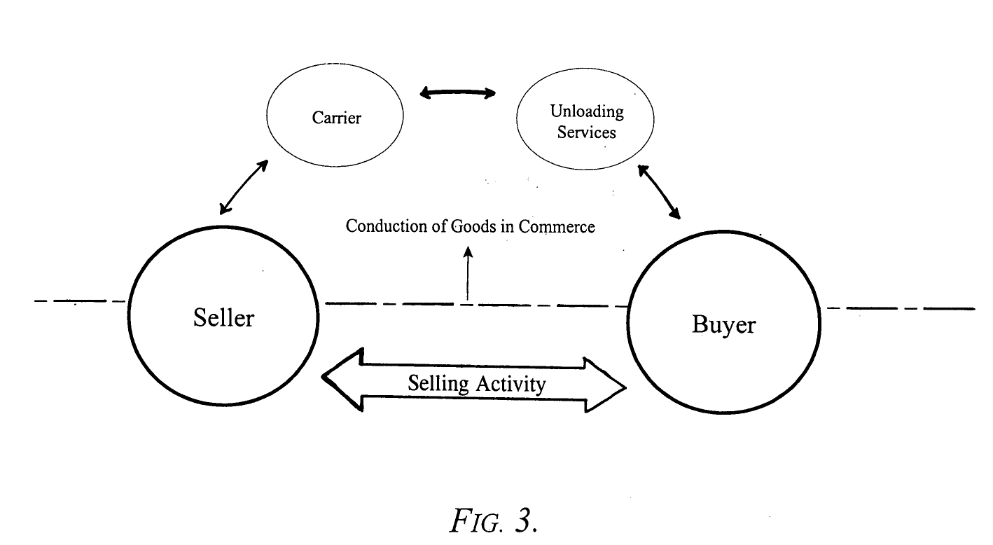

Pause can be taken now, to re-consider and re-entertain a fresh overview of this whole enterprise. Indeed, this re-consideration shall be so thorough as to trace the origin and evolution of such trailer-truck unloading services. FIG. 3 shows what should be an optimized conduction of goods market between a seller and buyer. The heavy negotiations traffic should be between the seller and buyer over price and other terms for product, including quality and quantity and delivery and so on. Thus the optimized “heavy” negotiations traffic is depicted as being solely between the buyer and seller in FIG. 3 and is illustrated by the thick arrow labeled “selling activity.”

Presumptively the buyer describes a delivery destination during this selling activity. In other words, for the product(s) to be actually delivered to buyer, the product(s) have to be launched into the “realm of conduction of goods” to get there. Needless to say, the seller has one or more points of origination for its product(s). Also, the seller has evolved in such a specialized world to be a specialist at designing, constructing or formulating its product. The seller is not traditionally in the business of trailer-truck carrier services as well. Hence the seller sources that work to outside vendors:—trailer-truck carriers.

In yesteryears, the costs of conduction of goods used to be confined to the fees of the carrier. Whether inexpensive or expensive, the fees of the carrier were (and are) a known quantity which is accounted for in the selling activity between the seller and buyer.

However, two or more factors worked in concert to spawn and then firmly establish continued viability for unloading-service contractors. These three comprise at least the following:—the USDOT Hours of Service rules on drivers for carriers, and warehouse management's desire to restrict creation of unionized jobs.

Those two factors will be reviewed briefly as follows. That is, the USDOT imposed rules on how many hours of service a driver can put in without having to take a ten hour or so layover. That is, a driver can only drive for eleven hours before he or she has to take a mandatory break. If he or she is off-duty during the beginning and end of the driving day, then he or she can take a maximum of four hours off-duty. That way, the driver can combine eleven hours of driving with four hours of off-duty time to aggregate a fifteen hour day.

If the driver can hand-over the offloading duties to an offloading subcontractor, the driver is offloading and hence preserving time for his or her eleven hour driving day. If on the other hand the driver has to unload his or her own trailer, then the driver is not considered off-duty and this cuts into his or her driving day.

Consequently, in a highly competitive retail economy, the following things shook out. Sellers and buyers both desired that carriers control costs. Therefore, both buyers and sellers became more persuaded of the value of a new specialized service-provider, the unloading service-provider (albeit given in some circles the unflattering name “lumper”). That way, drivers could preserve their USDOT Hours of Service in favor of lower paid work of the unloading-service worker.

It may be natural to ask why the buyer's warehouse did not provide such help with unloading. Originally, they got used to the drivers doing it themselves. Also, most of the employees at warehouses are unionized and therefore warehouse management would be reluctant to add workers to unionized jobs. However, the drivers of the carriers introduced non-unionized unloaders who were tolerated by the unions. Hence, the unloaders were legitimized and/or consented to by drivers, warehouse management and the union membership thereof. So, number three, the third step in the evolution and confirmation of the viability of the unloaders was the warehouse management's desire to not create new unionized jobs.

Problems started to crop up. Unloaders started to get injured during the work. They were uninsured or under-insured and so they got lawyers who sued the carriers and/or buyers for creating unsafe work environments or occasions. To counter this, the unloaders were encouraged and/or forced to organize under organizations which would insure them with health and/or disability insurance. To date, organizations exist which do provide such insurance coverage, but such organizations are also subject to undue control and/or influence by the most proximate party, and that is warehouse management.

During this same decade that witnessed the spawning and acceptance of the viability of unloading services, American business management entered a phase where a business enterprise was diagnostically sliced in separate “profit centers.” Each manager of such a denominated “profit center” would be held to an annual day of reckoning when he or she would justify to upper management for either his/her bonus or simply career based on the numbers turned for his/her profit center.

This new business-school fascination with differentiating an enterprise into separate profit centers has led to absurd results. It can be found today that many business consider their janitorial department a “profit center.” Each year, the manager of the janitorial department is pressured to show lower and lower costs for what is essentially an overhead cost.

More pertinent to unloading services, warehouse management was called upon to transform the warehouse operations into a profit center. They did so, finding a convenient tool for abuse in the unloading service organization.

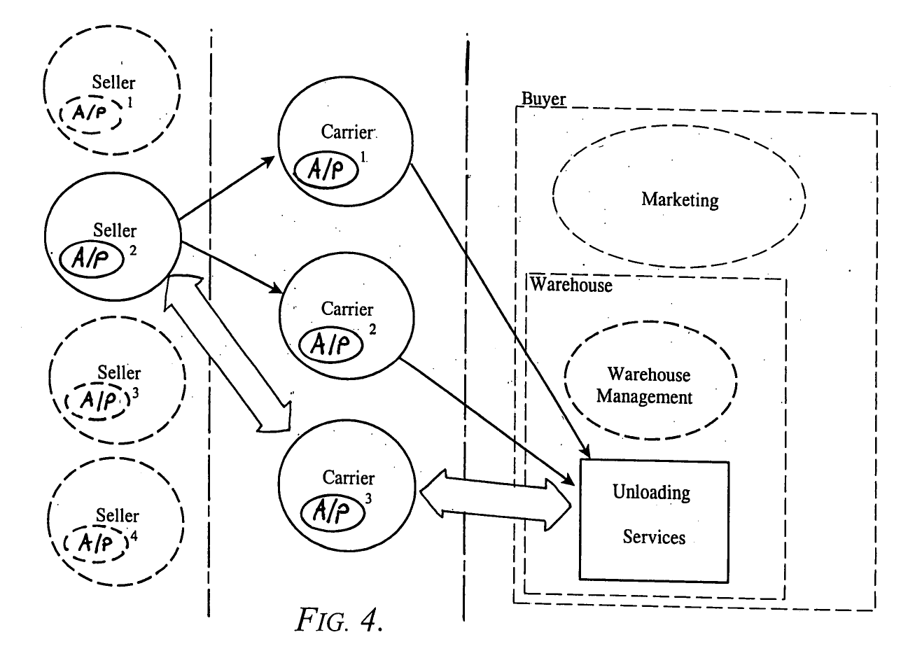

FIG. 4 shows the outcome of pressuring warehouse management to show profits for warehouse management. It is immediately recognizable that an unloading service can only operate under the grant of a concession of warehouse management. That is, the unloading service must operate on the premises of the warehouse owned not by it but by the buyer. The conventional contract service calls for the unloading service to pay the warehouse a commission (eg., twenty percent) of all its unloading fees as coverage for use of equipment like fork lifts and pallet jacks and the like. Additionally, warehouse management began to charge a “use” fee to all carriers who backed-in a trailer to any of their doors at their receiving dock. All that is except favored deliveries. The warehouse management could arbitrarily waive the “use” fee for certain deliveries for favored deliveries.

FIG. 4 also shows that a buyer in this sort of conduction of goods market is a large-scale buyer. It buys from numerous sellers. Each seller contracts with numerous carriers to carry product to the buyer's warehouse. Sellers might by habit of doing business contract predominantly but not exclusively with one carrier. Sellers might have smaller contracts with numerous other carriers besides their one predominant carrier.

FIG. 4 also shows that the buyer is a composite organization. That is, the buyer has, among others, a marketing department. Among those others, the buyer's departments includes for simplicity a warehouse management department. Under the currently-vogue “profit-center” business management style, the two departments work at cross-purposes. The marketing departments responsibility it is to bring in saleable product which reaps profit for the buyer organization as a whole. The warehouse management's short-sighted goal is to drive up costs for delivery of product so that the warehouse operations can show a profit. It needs not saying that increasing the cost of delivery of product will ultimately increase the cost of goods, making the buyer's price level less competitive in the market.

Nevertheless, to date there has not been a reckoning between the marketing department (whose desire is to keep the cost of goods down) and the warehouse department (whose sole aim is to show a profit for its own operations, regardless if that drives the cost of goods up) because, to the best explanation that can be offered, such a buyer organization is too large to micro-investigate every facet of its operation which impacts cost of goods.

Again, FIG. 4 shows that the buyer's warehouse management has undue influence over the unloading service's operations. The unloading service cannot, as FIG. 3 suggests, bargain at arms length with both carriers and the buyer's warehouse management. In contrast, FIG. 4 shows that the unloading service is subject too undue influence to the buyer's warehouse management because of the need to be granted a concession to do business on the premises of the warehouse:—and with the warehouses equipment in many instances including use of fork lifts and/or pallet jacks and the like.

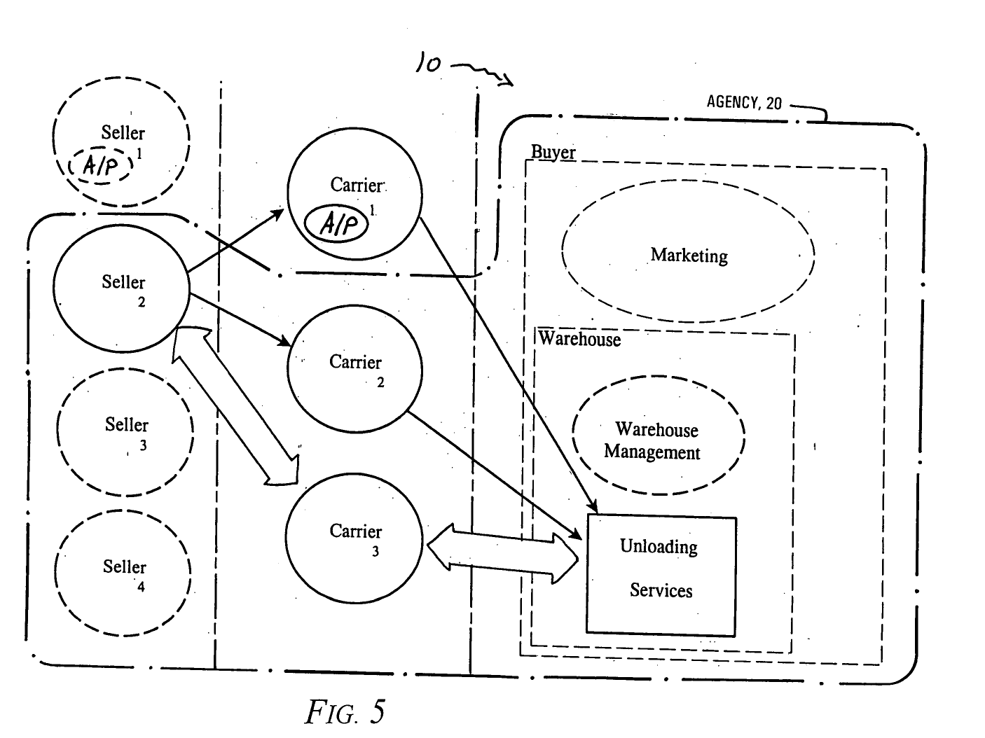

FIG. 5 shows the advantages of the invention for overcoming the shortcomings of the present day state or affairs.

A method of managing trailer-truck unloading services fees in a conduction of goods market with a large-scale buyer comprises establishing a service-enterprise or agency which takes on customers/clients from predominantly among the seller community. The agent 20 is designed to utilize the leverage power of its customers/clients in order to negotiate terms with the unloading service regarding fees for trailer-truck unloading at the receiving dock of the buyer's warehouse.

The agent 20 will negotiate rates, terms and any special conditions relating to unloading and sorting of product from deliveries that each individual customer/client (eg., shipper) will approve for itself.

It is preferred if the agent 20 is further designed to negotiate and furthermore concludes terms with not only the unloading service but also the buyer regarding fees for trailer-truck unloading at the receiving dock of the buyer's warehouse.

Negotiations with buyers are virtually limited to occur under three specific situations. First, if it is the receiver (buyer) who provides the unloading service for a fee, then the agency 20 will negotiate rates directly with the receiver (buyer).

Second, if the unloading service at the receiver's facility refuses to negotiate, then the agency 20 will approach the receiver (buyer) to discuss the program and enlist its (the receiver's) help in bringing the unloading service to the negotiating table.

Third, if the receiver uses the services of independent “lumpers” and not a formal service, the agency 20 will negotiate with the receiver (buyer) to convince the unloaders to organize in a formal business structure with the required insurance or replace said independent “lumpers” with an insured service.

Other negotiations with the buyer might include fees controlled by the buyer or warehouse management thereof which sellers/carriers find problematical. Examples include the use fees for trailers that utilize the warehouse's receiving dock for an unload. These seem like needless taxes that inflate the warehouse's reportable “profits” at the expense of the buyer's efforts as a whole to minimize needless inflations of costs of goods. It is more preferential still that the terms negotiated and concluded with the buyer more completely reach into and determine the terms of the concession granted by the buyer to the unloading service.

It is a preferred function of the agent 20 to negotiate and conclude terms that set forth a table of standard rates for unloading service fees according to systematized criteria. Such a systematized criteria of the rate table optionally comprises:
item description;
quantity description including number of pallets, cases, cartons, or other;
loaded-on-trailer configuration description including slip-sheeted, palletized, floor-loaded or other; and
offload-at-warehouse configuration description.
   More particularly, it is preferential if some of the foregoing more particularly address the following matters wherein:
the item description further includes SKU designations;
the quantity description further includes rate-increases for extraordinary weight or bulk;
the slip-sheeted designation denotes that a slip-sheeted bundle requires lifting by fork lift requires the cooperation between two workers of the unloading service, one to slide a pallet under the slip-sheeted bundle after a preliminary lift, and the other to operate the fork lift both for the preliminary lift and then thereafter for the more durable lift and transit of the pallet;
the palletized designation denotes that the involved pallet may be lifted by either a fork lift or pallet jack and that handling thereof requires only a single work of the unloading service;
the floor-loaded designation denotes that the handling thereof requires manual work, not a fork lift; and,
offload-at-warehouse configuration description includes description of how and generally where offloaded material shall be sorted and stacked for the warehouse's purposes, and rates for such labor are based on standardized labor charges to transfer such material from the loaded-on-trailer configuration to the offload-at-warehouse configuration.

It is a further preferred function of the agent 20 if it provides accounting services which pay the unloading service and/or buyer for fees associated with trailer-truck unloading services and/or dock use. This would consequently discharges carriers from being responsible for settling payment with the unloading service and/or buyer for such fees upon each instance of truck-trailer unload.

Preferably these accounting services are set-up to set forth defined reporting periods whereby the agent 20's accounting services pay the unloading service and/or buyer for fees associated with trailer-truck unloading services and/or dock use after the end of such reporting periods for all the unloads during that reporting period (eg., as on behalf of customers/clients). The agent 20's accounting services optimally consolidate all unloading fees incurred by each customer/client (eg., seller) into a plurality of invoices or sets of invoices at the end of pre-determined invoicing periods, one invoice or sets thereof solely for each such customer/client (eg., seller) according to fees incurred thereby.

It is even a moreover refined preference if each invoicing period's one invoice or sets thereof solely for each such customer/client (eg., seller) provides itemized documentation of all fees incurred.

The itemized documentation is especially valuable because to date the transactions of the unloading service(s) has (have) largely been undocumented. Hence there has been no paper (audit) trail to date to bring sunshine onto the systemic problems with the current state of affairs. To solve this lack of a paper (audit) trail, the itemized documentation preferably includes:
bill-of-lading number;
carrier identity;
load information including line items or SKU's as well as pallets, cases, cartons, or other;
after-the-fact determinations of overages, shortages or damages; and
time schedule information including estimated arrival time; actual arrival time;

unload and re-load, if any, completion time which comprises the presumptive earliest possible departure time; and departure time.

Some of the foregoing matters might more particularly include the following, such as wherein:

the carrier's identity includes any of truck, trailer or driver identity; and
the time schedule information allows audit of reported driver detention time for discrepancies.

Also, the paper (audit) trail might furthermore include:

bad-pallet re-stack fees,

shifted-load re-stack fees, and

rejected goods re-load fees;

portions or all of which might ultimately be the responsibility of the carrier or someone other than the seller.

Given the foregoing, the agent 20 is invested with powers and duties which relieve carriers of:
their drivers having to negotiate an unloading fee upon each arrival at the buyer's warehouse;
their drivers from having to communicate with the carrier's office for authorization to accept the fee;
the carrier's home office from having to pause such communications with the driver while communication is made to the seller for gaining the seller's ultimate acceptance of fees the seller might arguably balk at reimbursing;
the costs of such communications over radio and satellite networks;
the costs of bookkeeping just to keep the books for such transactions;
the necessity for drivers to exchange payment at the dock for such fees with a worker of the unloading service; and
the costs of electronic forms of payment for such one-load-at a time payments.

Additionally, the agent 20 establishes a conduction of goods market which provides the unloading service with:
a reasonably certain advance schedule of incoming work which, when proves true, is guaranteed work;
a better basis to forecast worker-number needs, costs and income; and,
forms of payment which shall eliminates worker theft on the dock.

Moreover, the agent 20 establishes a conduction of goods market which provides the buyer's warehouse management with:
potentially reduced trailer-time at any door of the dock;
potentially increased number of “turns” at a door of the dock each day; and
potentially increased revenues by not only eliminating theft by workers of the unloading service but also reducing driver unloads because of reasons including unreasonable/unanticipated fees demanded by workers of the unloading service, whereby driver unloads corresponding reduce warehouse revenues by depriving the warehouse of a commission charged to the unloading service on the unloading service's fees.

As for the carriers, the system and method in accordance with the invention not only benefits them (the carriers) by their exclusion from the program but also by the savings of internal costs as described above. The carriers aid in the growth and acceptability of the inventive program by spreading word of it to shippers which are either unaware of the inventive program or are skeptical of the true benefits thereof. The carriers, like the sellers, have a mutual interest in reigning in the problematic charges and in order to strengthen their leverage in proportion to their unified acceptability of program in accordance with the invention.

It is preferential still if the agent 20 is further designed to negotiate and furthermore concludes terms with the unloading service regarding mandatory insurance coverage and limits for any of worker's health, worker's disability, and/or property damage.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

We claim:

1. A method of managing trailer-truck unloading services fees in a conduction of goods market with a large-scale buyer, said method comprising the steps of:
providing a large-scale buyer of numerous diverse products with a central or regional warehouse for receiving delivery of such products in bulk at a receiving dock thereof; said warehouse being adapted for supplying plural retail outlets which are service by the buyer at later times;
providing a plurality of sellers of a variety of competing and non-competing products with purchase contracts from the buyer for itemized products;
providing a plurality of truck-trailer carriers with contracts from the sellers to carry itemized products thereof from origins of the sellers' to the receiving dock of the buyer's warehouse;
providing a trailer-truck unloading service with authority from the buyer to operate and conduct trailer-truck unloading services on the receiving dock of the buyer's warehouse for trailer-truck deliveries of sellers' itemized products by the carriers, and charging fees therefor to the sellers and/or carriers; and
providing a service-provider with customers subscribed from among the sellers, and being adapted to negotiate terms with the unloading service regarding fees for trailer-truck unloading and product sorting at the receiving dock of the buyer's warehouse;
wherein said service-provider concludes terms with the unloading service regarding fees for trailer-truck unloading and product sorting at the buyer's warehouse.

2. The method of claim 1 wherein service-provider is further adapted to negotiate and furthermore concludes terms with not only the unloading service but also the buyer regarding fees for trailer-truck unloading at the receiving dock of the buyer's warehouse.

3. The method of claim 2 wherein the terms negotiated and concluded with the buyer include any use fees for trailers that utilize the warehouse's receiving dock for an unload.

4. The method of claim 2 wherein the terms negotiated and concluded with the buyer moreover determine terms of the authority granted by the buyer to the unloading service.

5. The method of claim 1 wherein the service-provider negotiates and concludes terms including a table of standard rates for unloading service fees according to systematized criteria.

6. The method of claim 5 wherein the systematized criteria of the rate table comprise:
item description;
quantity description including number of pallets, cases, cartons, or other;
loaded-on-trailer configuration description including slip-sheeted, palletized, floor-loaded or other; and
offload-at-warehouse configuration description.

7. The method of claim 6 wherein after the step of the service-provider negotiating terms, and prior to the step of the service-provider concluding terms, the customer-sellers participate in a process by which they pre-approve the terms.

8. The method of claim 6 wherein:
the item description further includes SKU designations;
the quantity description further includes rate-increases for extraordinary weight or bulk;
the slip-sheeted designation denotes that a slip-sheeted bundle requires lifting by fork lift requires the cooperation between two workers of the unloading service, one to slide a pallet under the slip-sheeted bundle after a preliminary lift, and the other to operate the fork lift both for the preliminary lift and then thereafter for the more durable lift and transit of the pallet;
the palletized designation denotes that the involved pallet may be lifted by either a fork lift or pallet jack and that handling thereof requires only a single work of the unloading service;
the floor-loaded designation denotes that the handling thereof requires manual work, not a fork lift; and,
offload-at-warehouse configuration description includes description of how and generally where offloaded material shall be sorted and stacked for the warehouse's purposes, and rates for such labor are based on standardized labor charges to transfer such material from the loaded-on-trailer configuration to the offload-at-warehouse configuration.

9. The method of claim 5 wherein the service-provider provides accounting service which pays the unloading service and/or buyer for fees associated with trailer-truck unloading services and/or dock use, and consequently thereby discharges carriers from being responsible for settling payment with the unloading service and/or buyer for such fees upon each instance of truck-trailer unload.

10. The method of claim 9 wherein the negotiated and concluded terms include reporting periods, and the service-provider's accounting service pays the unloading service and/or buyer for fees associated with trailer-truck unloading services and/or dock use after the end of such reporting periods for all the unloads during that reporting period on behalf of participating customers.

11. The method of claim 9 the service-provider's accounting service consolidates all unloading fees incurred by each seller-customer into a plurality of invoices or sets of invoices at the end of pre-determined invoicing periods, one invoice or sets thereof solely for each such seller-customer according to fees incurred thereby.

12. The method of claim 11 wherein each invoicing period's one invoice or sets thereof solely for each such seller-customer provides itemized documentation of all fees incurred.

13. The method of claim 12 wherein the itemized documentation includes:
bill-of-lading number;
carrier identity;
load information including line items or SKU's as well as pallets, cases, cartons, or other;
after-the-fact determinations of overages, shortages or damages; and
time schedule information including estimated arrival time; actual arrival time;
unload and re-load, if any, completion time which comprises the presumptive earliest possible departure time; and departure time.

14. The method of claim 13 wherein:
the carrier's identity includes any of truck, trailer or driver identity; and
the time schedule information allows audit of reported driver detention time for discrepancies.

15. The method of claim 12 wherein the itemized documentation includes:
bad-pallet re-stack fees,
shifted-load re-stack fees, and
rejected goods re-load fees;
portions or all of which might ultimately be the responsibility of the carrier or someone other than the seller.

16. The method of claim 1 wherein the service-provider is invested with powers and duties which relieve carriers of:
their drivers having to negotiate an unloading fee upon each arrival at the buyer's warehouse;
their drivers from having to communicate with the carrier's office for authorization to accept the fee;
the carrier's home office from having to pause such communications with the driver while communication is made to the seller for gaining the seller's ultimate acceptance of fees the seller might arguably balk at reimbursing;
the costs of such communications over radio and satellite networks;
the costs of bookkeeping just to keep the books for such transactions;
the necessity for drivers to exchange payment at the dock for such fees with a worker of the unloading service; and
the costs of electronic forms of payment for such one-load-at a time payments.

17. The method of claim 1 wherein the service-provider establishes a conduction of goods market which provides the unloading service with:
a reasonably certain advance schedule of incoming work which, when proves true, is guaranteed work;
a better basis to forecast worker-number needs, costs and income; and,
forms of payment which shall eliminates worker theft on the dock.

18. The method of claim 1 wherein the service-provider establishes a conduction of goods market which provides the buyer's warehouse management with:
potentially reduced trailer-time at any door of the dock;
potentially increased number of “turns” at a door of the dock each day; and
potentially increased revenues by not only eliminating theft by workers of the unloading service but also reducing driver unloads because of reasons including unreasonable/unanticipated fees demanded by workers of the unloading service, whereby driver unloads corresponding reduce warehouse revenues by depriving the warehouse of a commission charged to the unloading service on the unloading service's fees.

19. The method of claim 1 wherein the service-provider negotiates with the buyer if:
the buyer and not an unloading service does the unloading work directly, in which case the service-provider negotiates rates directly with the receiver buyer;
the unloading service at the buyer's warehouse refuses to negotiate, in which case the service-provider negotiates with the buyer to bring the unloading service to the negotiating table; or
the buyer uses the services of independent “lumpers” and not a formally-organized unloading service, in which case the service-provider negotiates with the buyer to convince said independent “lumpers” to organize in a formal business structure with required insurance or else replace said independent “lumpers” with an insured unloading service.

20. The method of claim 19 wherein service-provider is further adapted to negotiate and furthermore concludes terms with the unloading service regarding mandatory insurance coverage and limits for any of worker's health, worker's disability, and/or property damage.
